(19) United States
(12) Patent Application Publication
(10) Pub. No.: US 2005/0108018 A1
(43) Pub. Date: May 19, 2005

(54) Accumulation medium operation system and accumulation medium operation method

(75) Inventors: Yasuhisa Nakajima, Kanagawa (JP); Hidehisa Miyashita, Tokyo (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 10/496,895

(22) PCT Filed: Sep. 24, 2003
(86) PCT No.: PCT/JP03/12167

(30) Foreign Application Priority Data
Sep. 25, 2002 (JP) 2002-279623

(51) Int. Cl. G06F 17/60

(52) U.S. Cl. 705/1

(57) ABSTRACT

A storage media operational system is composed of a server apparatus that a service enterprising person (provider) (103) performs management, and electronic equipments each comprising storage medium accessible through network from the server apparatus to make utilization contract with respect to the fact that a predetermined area within the storage medium of the electronic equipment between the service enterprising person (103) who performs management of the server apparatus and a contractor (101) who has the electronic equipment, whereby a predetermined area (rental area) of the electronic equipment in which the utilization contract has been made is operated through the network by the server apparatus. This utilization contract is caused to be rental contract which receives rental fee from the service enterprising person (103) as the equivalent that the contractor (101) lends the rental area of the electronic equipment. The server apparatus transmits, etc. contents such as CM, etc. to the rental area to operate such contents.

### TECHNICAL FIELD

The present invention relates to a storage media operational system composed of electronic equipments connected to network, and a server apparatus that service enterprising person (provider) connected to the network performs management, a storage media operational method therefor, and an electronic equipment and a server apparatus which constitute the storage media operational system.

Further, this Application claims priority of Japanese Patent Application No. 2002-279623, field on Sep. 25, 2002, the entirety of which is incorporated by reference herein.

### BACKGROUND ART

With popularization of Internet, personal computer and digital electrical appliances, etc., in order to individually store digital data produced therefrom to preserve such data, memory area of large capacity has been required. In view of the above, there is disclosed, in the Japanese Patent Publication Laid Open No. 2002-73840, a network server rental system in which in the case where it is difficult for individual to hold memory area of large capacity for taking back-up of data, etc., a portion of memory area that the server connected to the network holds is lent in accordance with request from contractor.

In the technology disclosed in this Publication, in the network server operational system composed of network as communication network, a server management center terminal and user terminals which are connected to the network, and a server connected to the server management center terminal, the server management center terminal comprises server rental contract means adapted for providing server rental information which lends memory area that the server holds on the network, and adapted so that in the case where the server terminal provides access to server rental information to transmit rental desired information to the server management center terminal, the server rental contract means lends memory area that the server holds in accordance with rental desired information. Thus, user who is the system contractor can lend memory area that the server connected to the network holds by the time period and the capacity that user wishes to use.

Meanwhile, manufacturers who manufacture these electronic equipments, etc. take goods (commodities) selling-out form to only sell goods with respect to purchasers who purchase goods. FIG. 1 is a model view showing ordinary business model example of goods selling. It is to be noted that explanation will be given below by taking the example where television broadcasting receiver maker and viewer who purchases that receiver to view television broadcast are respectively assumed as manufacturer and purchaser. As shown in FIG. 1, a television broadcast viewer 201 purchases a receiver of a desired receiver maker 202 to pay the receiver price thereof with respect to the receiver maker 202. By this payment, proprietary right (ownership) of the receiver is transferred from the receiver maker 202 to the viewer 201. In the case of such business model, when proprietary right is transferred from the receiver maker 202 to the viewer 201, the receiver maker 202 cannot produce profit (revenue) from that receiver from now on.

Moreover, after selling of goods, there are instances where business as described below holds. FIG. 2 is a model view showing service business model example after selling. As shown in FIG. 2, in the case where there exists a service enterprising person (provider) 203 which attempts to provide any service with respect to sold receiver, contract of service is made between the viewer 201 and the service enterprising person 203. In this case, the rental fee is paid from the viewer 201 to the service enterprising person 203 in accordance with the offered service. In dependency upon circumstances, a portion thereof may be caused to undergo revenue share to the receiver maker 202.

Further, there are instances where the receiver maker may offer goods to user through the service enterprising person without directly selling goods. FIG. 3 is a model view showing model of the rental type as such an example. The service enterprising person 203 gives an order of a receiver suitable for the service reception thereof to the receiver maker 202 in order to perform individual service to purchase that receiver. The receiver maker 202 receives payment of the cost of the receiver from the service enterprising person 203. The service enterprising person 203 lends the receiver to the viewer 201 to provide service. The viewer 201 pays, in a lump sum, rental fee (e.g., monthly fee) of the lent receiver, lending guarantee fee as occasion demands. The service enterprising person 203 pays (covers) the receiver fee and required cost by rental fee obtained from the viewer 201, and the remainder results in profit (revenue). In accordance with circumstances, a portion of that profit is caused to undergo revenue share to the receiver maker 202.

However, also in the all cases shown in FIGS. 1 to 3, when manufacturer receives prices of goods from purchaser, he cannot profit from goods servings as manufactured article from now on. In addition, when the purchaser pays prices of goods, depreciation takes place in accordance with use years of the goods. As a result, value of proprietary right of goods will be lowered.

On the other hand, in the technology described in the above-mentioned publication, contractor lends a portion of memory area that server holds in order to compensate shortage memory area. However, in recent years, there appear on the market many apparatuses provided with storage media of large capacity such as hard disc, semiconductor memory, optical disc and/or magneto-optical disc, etc. as a portion of personal computer, STB (Set-Top Box), and digital electrical appliance such as hard disc recorder, etc. As a result, there are cases where surplus of capacity of storage media takes place in homes, etc.

### DISCLOSURE OF THE INVENTION

The present invention has been proposed in view of conventional actual circumstances as stated above, and its object is to provide a storage media operational system, a storage media operational method therefor, an electronic equipment, and a server apparatus which can compensate lowering of goods value after purchase of an electronic equipment purchaser by making use of extra of capacity of a storage medium provided at the electronic equipment, and can produce profit of manufacturer from goods after selling.

The storage media operational system according to the present invention is directed to a storage media operational system including electronic equipments connected to network, and a server apparatus that service enterprising person (provider) performs management, wherein the electronic equipment includes a storage medium accessible through the network from the server apparatus, and communication means which communicates with the server apparatus through the network, and the server apparatus at least includes communication means which communicates with the electronic equipment through the network to make utilization contract in connection with the fact that a predetermined area within the storage medium of the electronic equipment is utilized between the server apparatus and the electronic equipment, whereby the server apparatus operates, through the network, the predetermined area of the electronic equipment in which the utilization contract has been made.

In the present invention, utilization contract in connection with the fact that a predetermined area of storage medium of the electronic equipment is made between an electronic equipment having an extra storage medium, e.g., for the reason why it is not used at present and a server apparatus that service enterprising person (provider) performs management to permit the server apparatus to operate the predetermined area of the storage medium of the electronic equipment.

Moreover, the utilization contract is permitted to be rental contract for allowing the electronic equipment to lend a predetermined area within the storage medium to the server apparatus by charge with rental fee, and the contractor can obtain rental fee in place of lending a predetermined area of the storage medium to the service enterprising person (provider). For this reason, lowering of value of proprietary right of electronic equipment by depreciation is reduced, and service enterprising person (provider) can freely use the predetermined area within the storage medium of the contractor in place of paying the price.

Further, the server apparatus can transmit contents such as commercial message, etc. to the predetermined area where the utilization contract has been made through the network.

Furthermore, the contents may be contents with viewing charge that owner receives viewing fee from the service enterprising person (provider) in the case where contractor who is owner of an electronic equipment in which the utilization contract has been made views the contents. Thus, it is possible to hasten viewing of contents of the contractor.

Moreover, the server apparatus may make contents transmission contract which transmits contents provided from the contents provider to a predetermined area within the storage medium through the network between the server apparatus and contents provider who provides contents, and the contents provider may provide contents with service intervention charge paid from the contents provider to the service enterprising person (provider). Thus, the service enterprising person can perform intervention between the contents provider and the contractor as service intervening enterprising person (provider).

Further, the service intervening fee paid from the contents provider to the service enterprising person (provider) of the contents with service intervening fee may include a first service intervention fee paid in the case where the contents are transmitted from the server apparatus to the predetermined area of the storage medium, and a second service intervention fee paid in the case where the contents are caused to undergo viewing. Thus, improvement in the service of the service enterprising person (provider) is hastened.

Furthermore, the server apparatus can select the contents on the basis of contractor information indicating at least one or more of the area (district) where contractor who is owner of an electronic equipment in which the utilization contract has been made, age of the contractor, interest of the contractor, presence or absence of viewing of the contents, size of capacity of a predetermined area within the storage medium, and rental time thereof to transmit selected one. For example, in the case where commercial message (CM) is transmitted as contents, it is possible to transmit contents in the state where the target is focused in a manner different from broadcast. For this reason, efficiency of advertisement is extremely high.

The storage media operational method according to the present invention is directed to a storage medium operational method for a storage media operational system including electronic equipments connected to network, and a server apparatus that service enterprising person (provider) performs management, wherein the electronic equipment includes a storage medium accessible through the network from the server apparatus, and communication means which communicates with the server apparatus through the network, and the server apparatus includes communication means which communicates with the electronic equipment through the network to make utilization contract in connection with the fact that the predetermined area within the storage medium of the electronic equipment is utilized between the server apparatus and the electronic equipment, whereby the server apparatus operates, through the network, the predetermined area of the electronic equipment in which the utilization contract has been made.

The electronic equipment according to the present invention is directed to an electronic equipment connected to a server apparatus that service enterprising person (provider) performs management, and includes a storage medium accessible through the network from the server apparatus, communication means for performing communication with the server apparatus through the network, and control means for permitting the server apparatus to operate a predetermined area within the storage medium through the network under the condition where utilization contraction with respect to the fact that the predetermined area has been made between the control means and the server apparatus.

The server apparatus according to the present invention includes electronic equipments connected to network, and a server device that service enterprising person (provider) performs management, wherein the electronic equipment includes a storage medium accessible through the network from the server apparatus, and communication means which communicates with the server apparatus through the network, and the server apparatus is directed to a server apparatus used in such a storage media operational system to include communication means which communicates with the electronic equipment through the network, and includes communication means which communicates with the electronic equipment through the network, and control means for making utilization contract in connection with the fact that a predetermined area within the storage medium of the electronic equipment is utilized between the control means and the electronic equipment to operate, through the network, the predetermined area of the electronic equipment in which the utilization contract has been made.

### BRIEF DESCRIPTION OF THE DRAWINGS

FIG. 1 is a model view showing business model example of conventional ordinary goods selling.

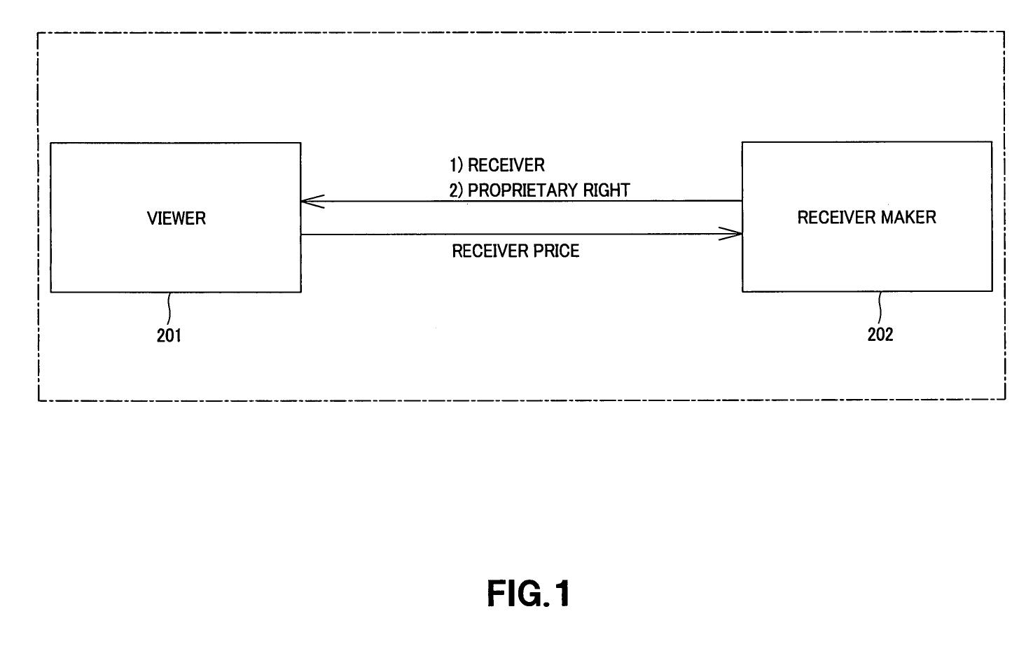

FIG. 2 is a model view showing conventional service business model example after selling.

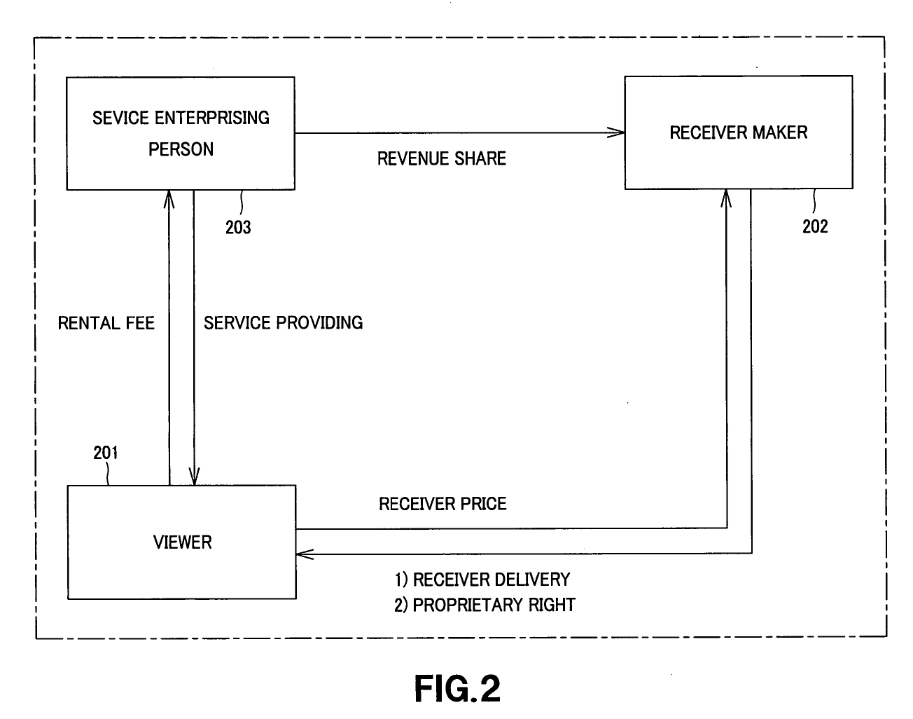

FIG. 3 is a model view showing a conventional rental business model example.

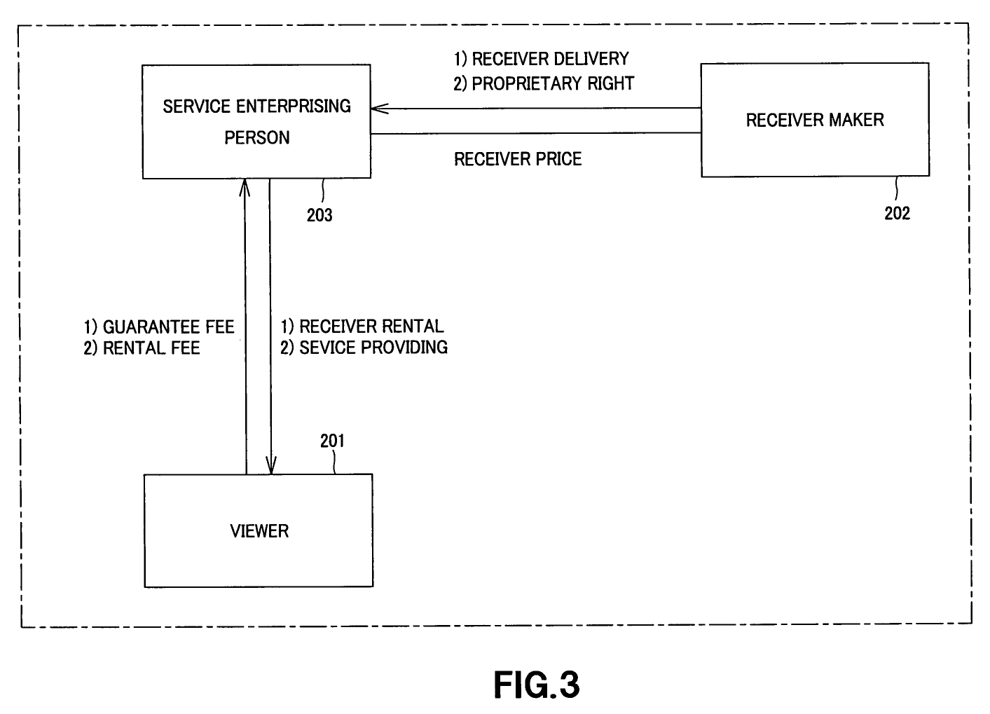

FIG. 4 is a model view showing a storage media operational system according to a first embodiment of the present invention.

FIG. 5 is a model view showing a storage media operational method according to the first embodiment of the present invention.

FIG. 6 is a flowchart showing a contracting method for rental contract between contractor and service enterprising person (provider) in the first embodiment of the present invention.

FIG. 7 is a model view showing initial picture of rental contract setting picture displayed on display portion of electronic equipment in rental contract in the first embodiment of the present invention.

FIG. 8 is a view similarly showing rental contract setting picture displayed on the display portion of electronic equipment in the rental contract in the first embodiment of the present invention, and is a model view showing rental area select picture of the setting picture.

FIG. 9 is a view similarly showing rental contract setting picture displayed on the display portion of electronic equipment in rental contract in the first embodiment of the present invention, and is a model view showing rental fee confirmation picture in hard disc utilization contract.

FIG. 10 is a model view of picture showing presentation example of CM sent through network from server apparatus of service enterprising person (provider) to rental area that contractor has lent.

FIG. 11 is a model view showing a storage media operational method according to a second embodiment of the present invention.

FIG. 12 is a model view showing a storage media operational method according to a third embodiment of the present invention.

### BEST MODE FOR CARRYING OUT THE INVENTION

Explanation will be given in detail with reference to the attached drawings in connection with practical embodiments to which the present invention is applied. In the embodiments, the present invention is applied to a storage media operational system including electronic equipments each including storage medium which are connected to network, and a server apparatus similarly connected to the network, whereby owner of the electronic equipment is caused to be contractor to make utilization contract which lends, to the server apparatus, at least a portion of one of storage media, e.g., hard disc, semiconductor memory, optical disc and/or magneto-optical disc, etc. of the electronic equipment between the electronic equipment that the contractor has and the server apparatus to thereby effectively operate storage media of the electronic equipments.

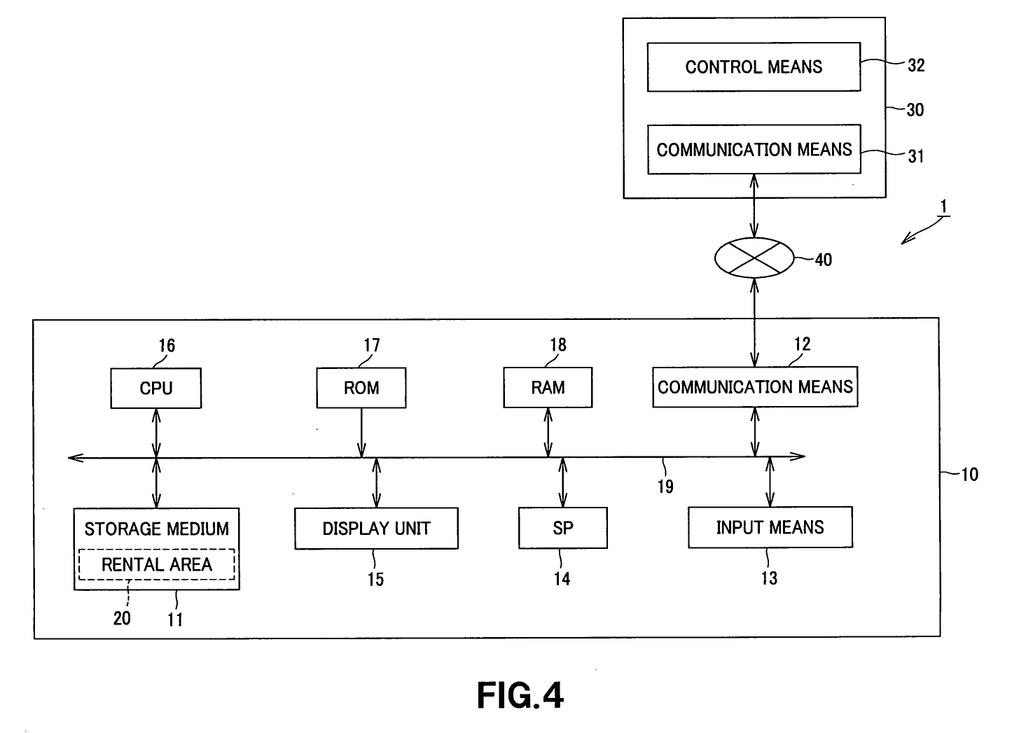

FIG. 4 is a model view showing the storage media operational system according to the first embodiment of the present invention. As shown in FIG. 4, the storage medium operational system 1 is a business model held by contract between contractor who has an electronic equipment 10 including a storage medium 11 and a service enterprising person (provider) who performs management of a server apparatus 30 similarly connected to the network 40. The storage media operational system 1 is composed of plural electronic equipments connected to the network 40, and server apparatus (service terminal) 30 similarly connected to the network 40 and operative to offer service to the electronic equipments 10 through the network 40. While explanation will be given below in the embodiments by exemplifying computer device as electronic equipment 10 which has storage medium 11 that the contractor uses for contraction, electronic equipments including fixed storage media, e.g., television broadcast image receiver, STB, hard disc recorder and/or game equipment, etc. may be employed as such electronic equipment 10.

In the electronic equipment 10, storage medium 11 such as hard disc, etc. accessible through the network 40 from the server apparatus 30, communication means 12 which communicates with the server apparatus 30 through the network 40, input means 13 such as mouse and/or keyboard, a speaker (SP) 14, a display unit 15, a CPU (Central Processing Unit) 16 serving as control means, a ROM (Read Only Memory) 17, a RAM (Random Access Memory) 18 are connected through a bus 19.

When the input means 13 is operated so that execution instruction of a predetermined processing is given, the CPU 16 is adapted to execute a predetermined operation on the basis of program stored in the ROM 17 or the storage medium 11, thus to execute various processing as the entirety of the computer device. Moreover, at this time, the CPU 16 reads out image data stored in the storage medium 11 as occasion demands on the basis of program stored in the storage medium 11 or the ROM 17 to give such data to the display unit 15 to thereby display a predetermined picture, and to display, on the display unit 15, cursor moved within picture in response to operation of the input means 13, or to display, on the display unit 15, numeral and/or character, etc. inputted from the input means 13.

Further, the server apparatus 30 includes communication means 31 which communicates with the electronic equipment 10 through the network 40, and control means 32 which makes utilization contract with respect to the fact that a predetermined area within storage medium 11 of the electronic equipment 10 is utilized between the control means 32 and the electronic equipment 10 to operate the predetermined area of the electronic equipment 10 in which the utilization contract has been made, whereby the control means 32 performs collection of the electronic equipment 10 which makes utilization contract with respect to the fact that the predetermined area within the storage medium 11 is utilized through the communication means 31. In the case where the CPU 16 serving as the control means of the electronic equipment 10 judges that it is permitted that a predetermined area within the storage medium 11 is lent to the server apparatus 30, i.e., in the case where the utilization contract is made between the electronic equipment 10 and the server apparatus 30, the CPU 16 serving as the control means for the electronic equipment 10 performs rental of a predetermined area of the storage medium 11 to the server apparatus 30. Thus, utilization contract is made between the server apparatus 30 and the electronic equipment 10 which permits utilization of the predetermined area, whereby the predetermined area in the storage medium 11 of the electronic equipment 10 is operated by the server apparatus 30 through the network. Here, the utilization contract in this embodiment is rental contract in which contractor receives rental fee from service enterprising person (provider) as the equivalent which lends a predetermined area within the storage medium 11.

The predetermined area within the storage medium 11 of the electronic equipment 10 which makes rental contract with respect to the server apparatus 30 is space area, etc. which can be lent for the reason why contractor who is owner of the electronic equipment 10 does not use this area for the present at the storage medium 11 such as hard disc, etc. included within the electronic equipment 10, and is accessible from the server apparatus 30 that the service enterprising person (provider) performs management through the network 40. Hereinafter, the predetermined area of the storage medium 11 in the electronic equipment 10 that the contractor uses for contraction will be called rental area 20.

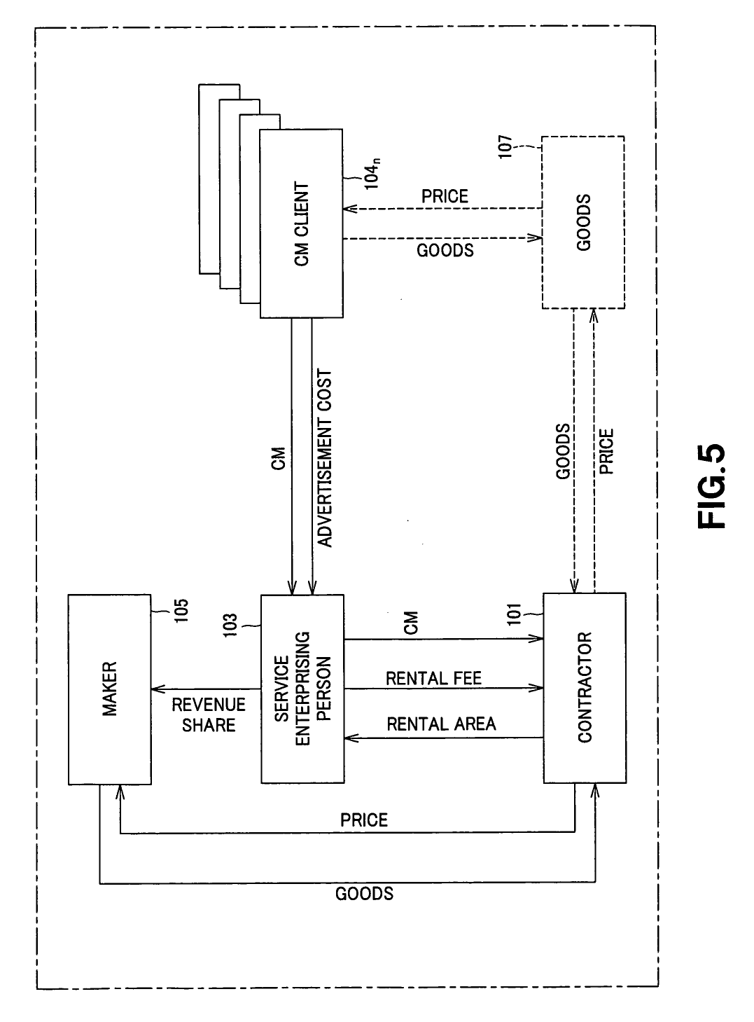

FIG. 5 is a model view showing an operational method for storage media operational system of this embodiment. As shown in FIG. 5, this storage medium operational system includes a contractor 101 having electronic equipment 10 which has made utilization contract (rental contract) with the server apparatus 30 shown in FIG. 4, a server enterprising person (provider) 103 which performs management of the server apparatus 30, and a CM client 104ₙ serving as contents provider who offers contents to the server apparatus 30, whereby rental area 20 of the electronic equipment 10 is operated between the contractor 101 and a maker 105 of the electronic equipment 10.

The service enterprising person (provider) 103 transmits, etc contents to the rental area 20 by the server apparatus 30 in place of paying the price (rental fee) to the rental area 20 which has been lent from the contractor 101 to have ability to freely use rental area 20. In this embodiment, explanation will be given by taking, as an example, the case where commercial message (infomercial) (hereinafter referred to as CM) is transmitted to the rental area 20 as contents.

In this embodiment, the service enterprising person (provider) 103 transmits, to the rental area 20, CM which has been provided from the CM client 104ₙ serving as contents provider in place of CM which the service enterprising person (provider) 103 himself prepares. Namely, the server apparatus 30 that the service enterprising person (provider) 103 performs management makes, with respect to CM client 104ₙ who provides CM, CM transmission contract which transmits CM which has been provided from CM client 104ₙ to the rental area 20 of the electronic equipment 10 of the contractor 101 through the network 40.

In this transmission contract, the service enterprising person (provider) 103 receives advertisement cost (first service intervention fee) from CM client 104ₙ as the equivalent for transmission of CM. Accordingly, the service enterprising person (provider) 103 first collects plural CM clients 104ₙ as the contents provider. As the CM client 104ₙ, e.g., manufacturer of electronic equipment 10, etc. that the contractor 101 has used for contraction, and/or manufacturer for various goods except for electronic equipment 10, etc. are mentioned. Further, the service enterprising person (provider) 103 transmits, to the rental area 20 of the contractor 101, CM provided from the CM client 104ₙ as intervention enterprising person (provider) between these collected CM clients 104ₙ and the contractor 101. Thus, the rental area 20 is operated through the network by the service enterprising person (provider) 103. In this instance, the service enterprising person (provider) 103 allots a portion of profit obtained as the result of the fact that the rental area 20 has been operated with respect to the maker 105 which has manufactured electronic equipment 10 provided with rental area 20, thereby making it possible to hasten the maker 105 to develop such electronic equipments (goods) that the rental area 20 is easily operated.

The contractor 101 receives rental fee from the service enterprising person (provider) 103 to lend the rental area 20 to transmit CM of the goods 107 from the service enterprising person (provider) 103 to the rental area 20.

The CM client 104ₙ hastens purchase of goods 107 of the contractor 101 who has viewed this CM by transmitting CM of the goods 107 to the contractor 101 in place of paying advertisement fee.

The operational method for storage media will be explained below. First, the contractor 101 purchases electronic equipment 10 from, e.g., electronic equipment maker 105 to pay the price thereof to the electronic equipment maker 105. By this payment, proprietary right of the electronic equipment 10 is transferred from the electronic equipment maker 105 to the contractor 101.

The contractor 101 lends a portion of the storage medium 11 of the electronic equipment 10 having proprietary right (ownership), e.g., a portion of hard disc included therein to the service enterprising person (provider) 103 as rental area 20. The service enterprising person (provider) 103 pays lending fee (rental fee) to the contractor 101 as rental fee of the lent rental area 20 of the lent electronic equipment 10. The contractor 101 obtains this rental fee to thereby partially compensate loss by depreciation to have ability to hold value.

The service enterprising person (provider) 103 makes the use right of the rental area 20 of the electronic equipment 10 which has been lent from the contractor 101 to collect CM clients 104 to provide service, i.e., advertisement in this embodiment.

The service enterprising person (provider) 103 collects the advertisement price from the CM client 104ₙ as service substitute fee as the equivalent that CM 141ₙ serving as contents transmitted from the CM client 104ₙ to the electronic equipment 10 of the contractor 101 is provided to transmit this CM to the rental area 20 of the electronic equipment 10 of the contractor 101 to compensate rental fee with respect to the rental area 20 paid to the contractor 101 so that extra results in profit of the service enterprising person (provider) 103. In addition, the service enterprising person (provider) 103 may perform revenue share with respect to the electronic equipment maker 105.

Here, rental fee that the service enterprising person (provider) 103 pays to the contractor 101 as the equivalent of the rental area 20, i.e., rental fee that the contractor 101 receives from the service enterprising person (provider) 103 can be determined by size and length of the rental period of the rental area 20 at the storage medium 11 that the contractor 101 lends, or combination of these conditions thereof, etc. The size and the rental period of the rental area 20 that the contractor 101 lends can be suitably set when the contractor 101 makes rental contract with the service enterprising person (provider) 103.

Moreover, the advertisement price that the CM client 104ₙ pays to the service enterprising person (provider) 103 is set by, e.g., resident area and interest or taste at plural contractors 101 who make contract with the service enterprising person (provider) 103, user group (age and sex, etc.) of the contractor 101 or the electronic equipment 10 that the contractor 101 has, the total number of contractors 101, capacity of the rental area 20, the rental period of the rental area 20, or combination of these conditions thereof, etc.

Further, the contractor 101 lends, as the rental area 20, a portion of the storage medium 11 of the electronic equipment 10 to the service enterprising person (provider) 103. In this case, it is preferable that this electronic equipment 10 is connected to Internet at all times in order to have ability to transmit contents at any time with respect to the rental area 20 of the electronic equipment 10 that the service enterprising person (provider) has lent. In the case where the electronic equipment 10 is not connected to the Internet at all times, it is sufficient that, e.g., the contractor 101 makes connection to Internet at a predetermined time, the contractor 101 himself down-loads CM from the service enterprising person (provider) 103 or a predetermined site through Internet, etc., or the service enterprising person (provider) 103 accesses and connects the electronic equipment 10 of the contractor 101, etc.

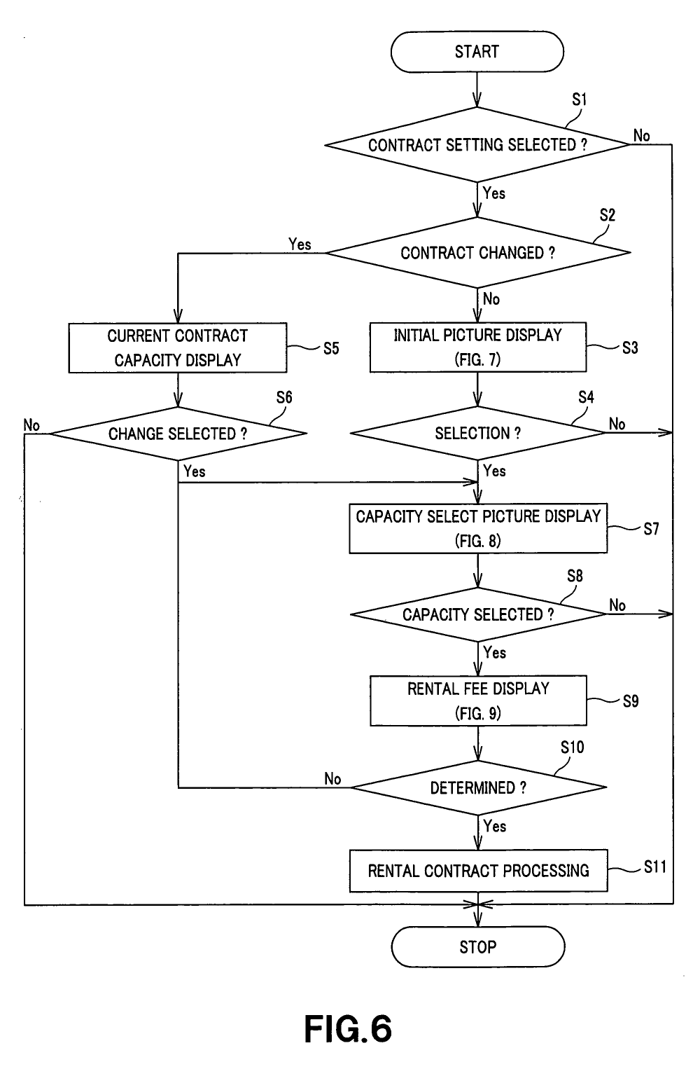

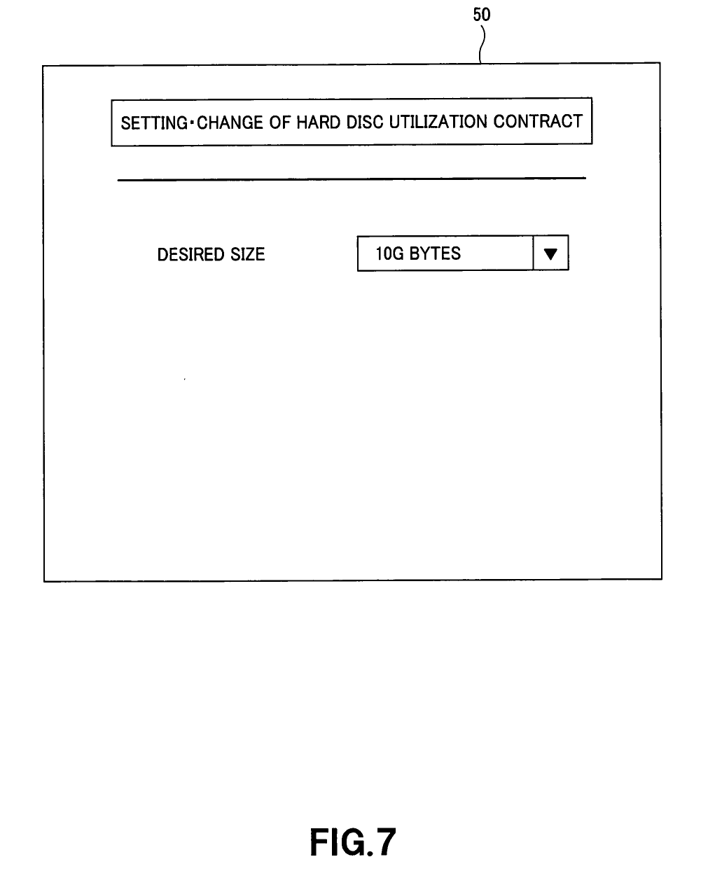

Then, explanation will be given in more detail in connection with the rental contract made between the contractor 101 and the service enterprising person (provider) 103. FIG. 6 is a flowchart showing a method of making rental contract made between the contractor 101 and the service enterprising person 103. Here, explanation will be given in connection with the case where the contractor 101 who has purchased the electronic equipment 10 makes contract by using rental contract setting picture displayed on display unit 15 of the electronic equipment 10. FIGS. 7 to 9 are model views showing examples of rental contract setting picture displayed on the display unit of the electronic equipment 10 in the rental contract.

As shown in FIG. 6, first, in the display unit of the electronic equipment 10, whether or not rental contract setting is selected is confirmed (step S1). In the case where the rental contract is not made, processing is completed. On the other hand, in the case where the rental contract is made, whether or not the rental contract is changed is confirmed (step S2). In the case where electronic equipment 10 is newly purchased, etc., since corresponding rental contract is not change of the rental contract, processing proceeds from step S2 to step S3 to display initial picture 50 in which setting change, etc. of hard disc utilization contract is displayed as shown in FIG. 7. Thus, whether or not the rental contract is made is selected (step S4), Here, in the case where the owner of the electronic equipment 10 who serves as the contractor 101 does not make the rental contract, processing is completed.

On the other hand, in the case where change of the rental contract is selected at the step S2, size of the rental area (contract capacity) 20 that the contractor 101 lends to the service enterprising person 103 in the present contract is displayed (step S5). Thus, whether or not the rental area 20 is changed is confirmed (step S6). In the case where the rental area 20 is changed, processing proceeds to step S7. In addition, in the case where the rental area 20 is not changed, processing is completed.

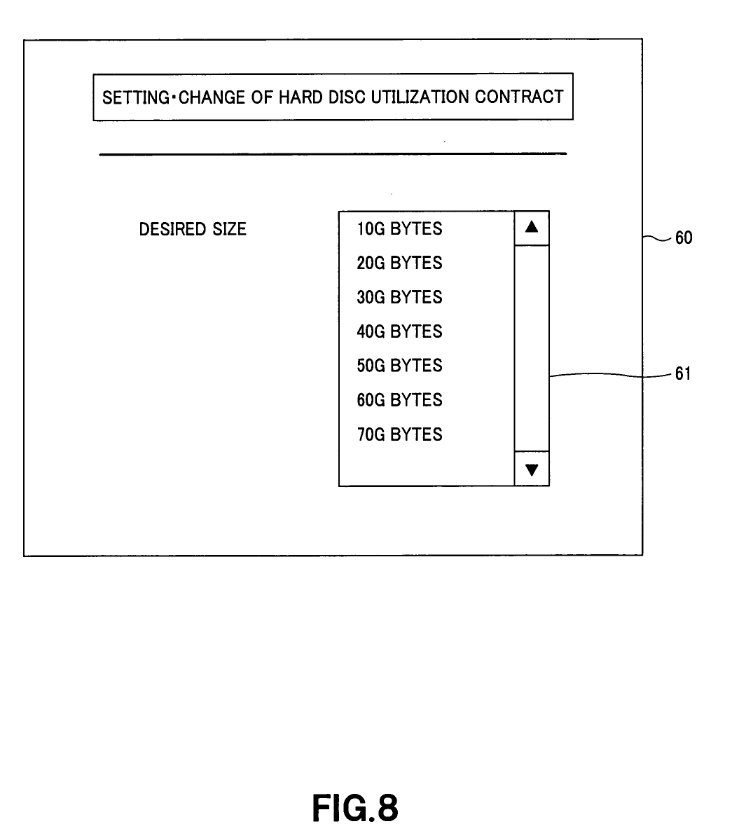

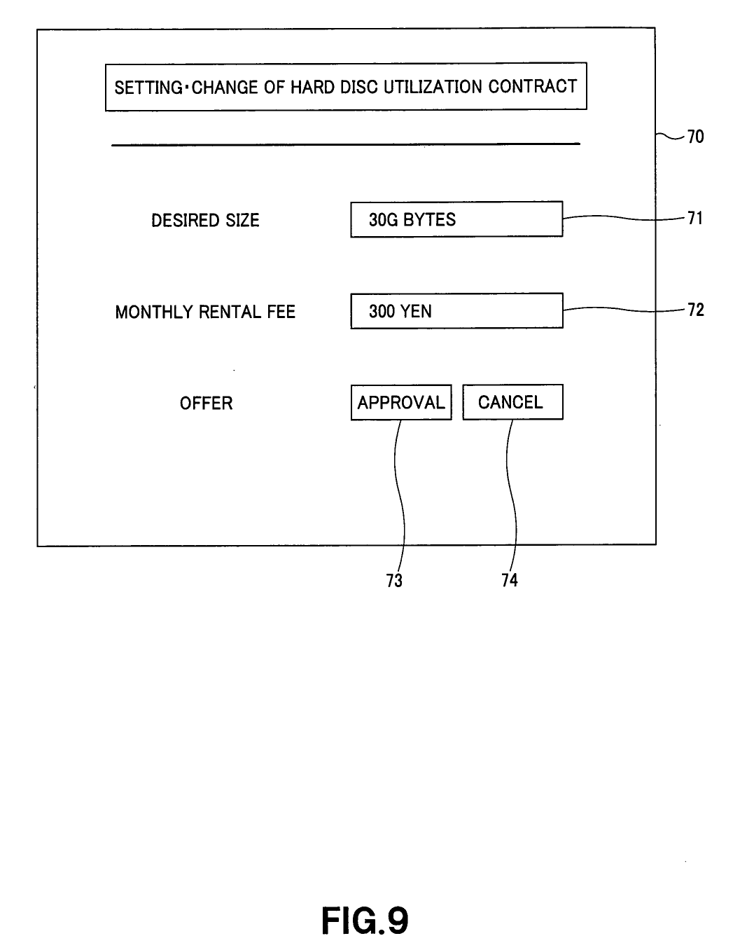

At the step S7, rental area select picture 60 shown in FIG. 8 is displayed. At the rental area select picture 60, there is included desired size selector means 61 for selecting desired size of the rental area 20, e.g., on giga byte basis, etc. so that it is lent. The contractor 101 selects lending desired size at this selector means to confirm whether or not the rental area 20 is selected (step S8). When it is confirmed that the rental area 20 has been selected, rental fee confirmation picture 70 indicating monthly rental fee 72 corresponding to lending desired size 71 is displayed as shown in FIG. 9 (step S9). The contractor 101 confirms desired size and its monthly use quantity at this picture to select approval button 73 or cancel button 74 (step S10). In the case where the cancel button 74 is selected, processing is repeated from the step S7. On the other hand, in the case where the approval button 73 is selected, the rental contract processing is performed (step S11). Thus, the rental contract processing between the contractor 101 and the service enterprising person 103 is completed. While it is assumed here that when the contractor 101 inputs desired size of the rental area 20, the monthly rental fee is automatically set, in the case where, e.g., plural service enterprising persons 103 are participated, the rental fee may be individually selected in dependency upon the CM client 104ₙ or the contents to be transmitted, or the contractor 101 himself may set the rental fee.

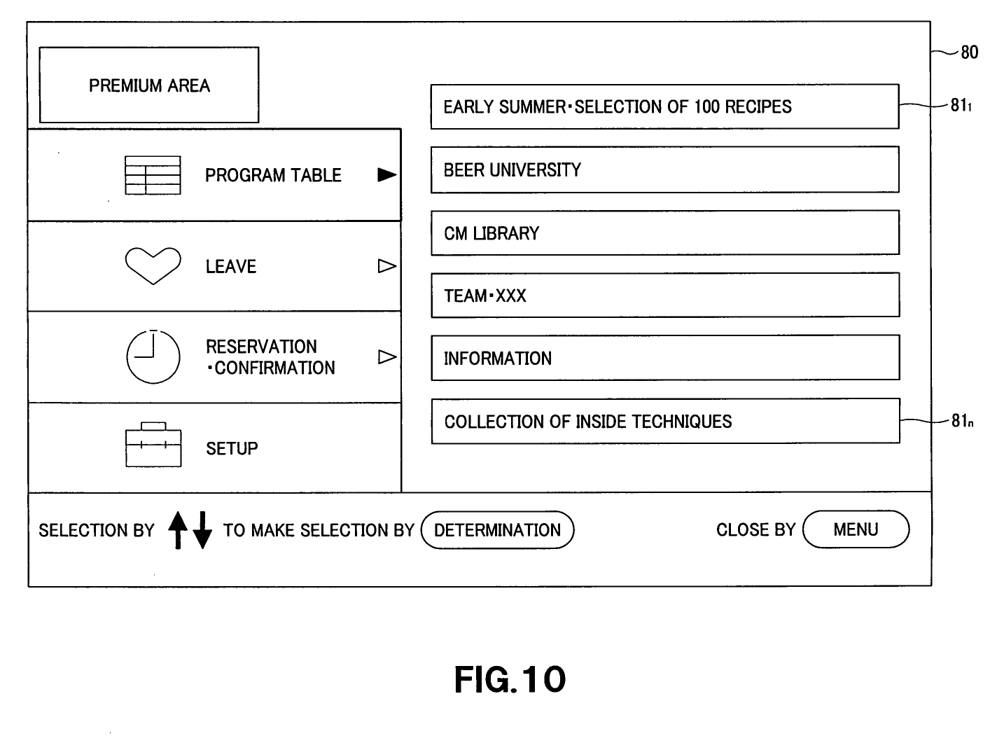

FIG. 10 is a model view of picture indicating presentation example of CM sent through the network 40 from the server apparatus 30 of the service enterprising person (provider) 103 to the rental area 20 lent from the electronic equipment 10 of the contractor 101. The service enterprising person (provider) 103 contracts with plural CM clients 104ₙ to transmit plural CMs to the rental area 20 of the contractor 101. With respect to CM to be sent, in order that the contractor 101 can quickly view desired CM, menu picture 80 is displayed as shown in FIG. 10. At this menu picture 80, various information items 81₁~81ₙ such as cooking recipe, sports and/or information, etc. are prepared, thus permitting the contractor 101 himself to view interested CM.

In the storage media operational system 1 constituted as described above, the contractor 101 lends a portion of the storage medium 11 of the electronic equipment 10 having proprietary right (ownership) which has been once acquired to the service enterprising person (provider) 103 as the rental area 20 to operate it to thereby have ability to obtain profit. Namely, the rental area can be obtained by the rental contract. As a result, it is possible to purchase the electronic equipment 10 at a cost lower than purchase cost.

Further, the service enterprising person (provider) 103 allots extra of profit to the electronic equipment maker 105 that the contractor 101 uses for the rental contract, whereby profit by service providing of the service enterprising person (provider) 103 is allocated to the electronic equipment maker 105 in addition to price by selling-out of the maker.

Furthermore, the service enterprising person (provider) 103 is not required to purchase the equipment as in the case of the above-described rental model, and selectively selects the number of equipments, the district and the user group as occasion demands so that effective service can be made.

Then, the second embodiment of the present invention will be explained. In the first embodiment, the contractor 101 receives rental fee as the equivalent that the rental area 20 is lent out, and CM transmission charge is paid from the CM client 104ₙ to the service enterprising person (provider) 103 as the equivalent that the service for transmitting CM to the rental area 20 is performed. On the contrary, the second embodiment differs from the first embodiment in that new charge is caused to take place in dependency upon presence or absence of viewing of CM. It is to be noted that, in the following embodiment, the same reference numerals are respectively attached to the same components as those of the first embodiment shown in FIGS. 4 and 5 and their detailed explanation will be omitted.

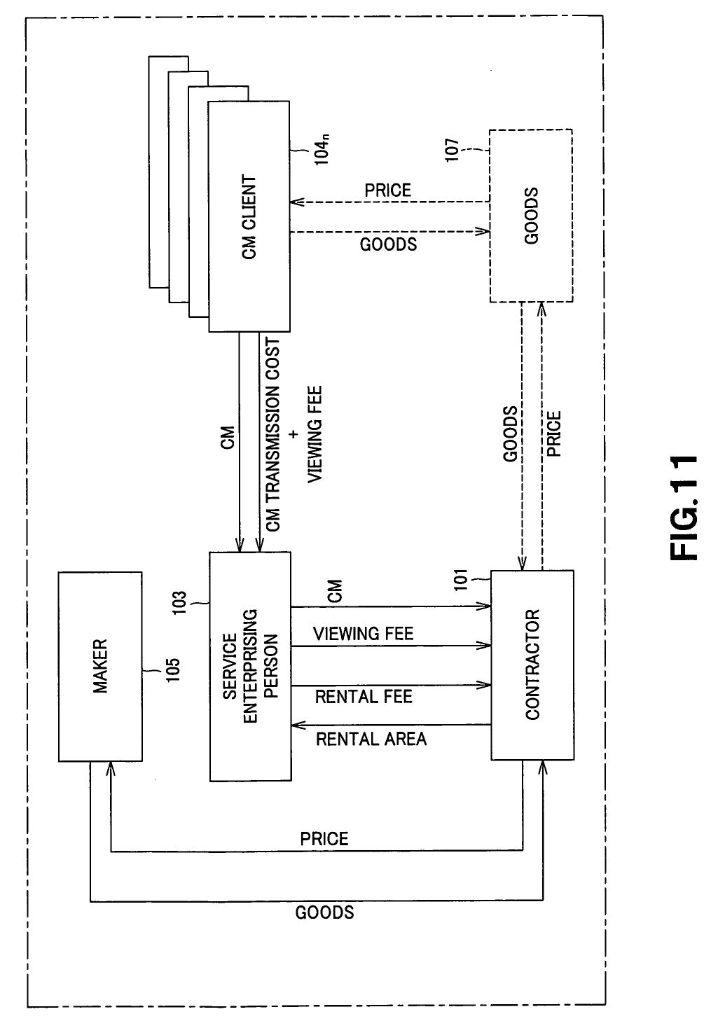

FIG. 11 is a model view showing the storage media operational method in the second embodiment of the present invention. In this embodiment, in the storage media operational system composed of electronic equipment 10, server apparatus 30 and network 40 which is shown in FIG. 4, means for detecting whether or not the contractor 101 has viewed CM is provided at the server apparatus 30. As shown in FIG. 11, when the contractor 101 has viewed CM transmitted from the service enterprising person (provider) 103, the contractor 101 collects separate fee (CM viewing fee) from the service enterprising person (provider) 103 as the equivalent thereof. Namely, CM which is contents transmitted from the service enterprising person (provider) 103 results in contents with viewing fee. Whether or not the contractor 101 has viewed CM is realized, e.g., by allowing the contractor 101 who has viewed CM to notify it through communication means 12 of the electronic equipment 10 with respect to the server apparatus 30, or is realized by distributing such detection software to detect that CM is viewed from the server apparatus 30 when the rental contract is made to notify it to the server 30 to install such detection software into the electronic equipment 10. Thus, according as the contractor 101 views CM transmitted to the lent rental area 20 of the electronic equipment 10 of the contractor 101 himself, its CM viewing fee is charged. Thus, it is possible to hasten viewing of CM of the contractor 101.

Further, in this embodiment, when the contractor 101 has viewed CM, the service enterprising person (provider) 103 can further collect advertisement price (second intervention fee) from the CM client 104ₙ. Namely, the advertisement price in the contents with advertisement charge offered from the CM client 104ₙ to the service enterprising person (provider) 103 consists of CM transmission cost (first service intervention fee) required for transmitting CM from the server apparatus 30 that the service enterprising person (provider) performs management to the electronic equipment 10, and viewing fee which can be received when the contractor 101 has viewed transmitted CM (second service intervention fee).

In a manner as stated above, in the case where CM that the CM client 104ₙ provides through the service enterprising person (provider) 103 is viewed by the contractor 101, and is significantly used, advertisement cost is added. Accordingly, there is no possibility that the advertisement cost may become waste. In addition, since advertisement cost is charged for the service enterprising person (provider) if the contractor 101 views CM, service of the service enterprising person (provider) 103 is improved.

Further, whether or not the contractor 101 views CM is detected, whereby the service enterprising person (provider) 103 grasps contractor information indicating CM with which that contractor 101 is interested to thereby select CM every contractor 101 to have ability to transmit the selected CM.

In addition, while the maker 105 sells electronic equipment 10 serving as goods to purchaser who is contractor in this embodiment, the maker 105 may be CM client 104ₙ as explained in the first embodiment, or may receive revenue share in cooperation with the service enterprising person (provider) 103.

Here, rental fee that the service enterprising person (provider) 103 pays to the contractor 101 as the equivalent of the rental area 20, i.e., rental fee that the contractor 101 receives from the service enterprising person (provider) 103 can be determined by presence or absence of viewing of CM, e.g., in addition to size and length of rental period, etc. of the rental area 20 that the contractor 101 lends which is similar to the above-described first embodiment, or combination of these conditions. The size and the rental period of the rental area 20 that the contractor 101 lends can be set when the contractor 101 makes rental contract with the service enterprising person (provider) 103 similarly to the above-described first embodiment. In addition, presence or absence of viewing of CM can be obtained by providing, e.g., means for detecting request from the contractor 101 or whether or not the contractor makes viewing within CM.

On the other hand, advertisement price that the CM client 104ₙ pays to the service enterprising person (provider) 103 can be set by presence or absence of viewing, e.g., in addition to district area and interest/taste at plural contractors 101 who make contraction with the service enterprising person (provider) 103, user kind of the contractor 101 or electronic equipment 10 that the contractor 101 has, total sum of contractors 101, capacity of the rental area 20 and the rental period of the rental area 20, or combination of these conditions.

These information may be provided from, e.g., the contractor 101 in the rental contract with the service enterprising person (provider) 103, or goods, etc. with which the contractor 101 is interested may be estimated on the basis of presence or absence of viewing of CM.

In addition, the rental contract made between the service enterprising person (provider) 103 and the contractor 101 may be performed by a method similar to the above-described first embodiment. Here, there may be provided, on setting picture at the time of such rental contract, input means such that the service enterprising person (provider) 103 can input various contractor information necessary for providing service such as residence, age and interest of the contractor 101, or the field with which he is interested, etc. Thus, the service enterprising person (provider) 103 cannot only obtain contractor information from presence or absence of viewing of CM, but also can precisely grasp information of the contractor 101.

In the storage media operational system in the second embodiment constituted in this way, similarly to the first embodiment, the contractor 101 lends a portion of the storage medium 11 of the electronic equipment 10 having proprietary right (ownership) which has been once acquired to the service enterprising person (provider) 103 as the rental area 20 to thereby have ability to obtain profit. By the rental contract, the electronic equipment 10 can be resultantly purchased at a cost lower than purchase cost. In addition, contents such that charging is conducted if sent CM is viewed is transmitted to thereby perform new effect that depreciation amount ordinarily taking place can be reduced as minimum as possible.

Moreover, in the contract between the contractor 101 and the service enterprising person (provider) 103, initial setting picture such that age group, interest field and residence area, etc. of the contractor 101, or the contractor (user) of that electronic equipment 10 can be inputted is provided, whereby the service enterprising person (provider) 103 can grasp contractor information of the electronic equipment 10 of the contractor 101 to have ability to selectively transmit CM of goods, etc. of the interested field. On the other hand, if the content of CM being transmitted is disclosed, etc. at the service enterprising person (provider) 103 side to provide selector means at the electronic equipment 10 of the contractor 101, the contractor 101 can select CM that the contractor himself is interested to transmit it from the service enterprising person (provider) 103. For both the service enterprising person (provider) 103 and the contractor 101, there results extremely less uselessness.

Further, the service enterprising person (provider) 103 collects advertisement cost with respect to CM when CM is transmitted to the rental area 20 of the contractor 101 from the CM client 104ₙ. In the case where the contractor 101 views CM transmitted to the contractor 101, advertisement price can be further collected from the CM client 104ₙ. For this reason, difference of amount is provided between the advertisement price in the case where CM is not viewed even if it is sent and the advertisement price in the case where CM is viewed, thereby making it possible to improve CM audience rating of the contractor 101.

Further, since the CM client 104ₙ can grasp goods with which the contractor 101 is interested from contractor information or CM viewing circumstances differently from broadcasting CM, e.g., television broadcast, etc., it is possible to select the contractor 101 to have ability to send CM (infomercial). Thus, advertisement can be extremely efficiently performed.

Then, the third embodiment of the invention will be explained. While explanation has been given in the case where the rental contractor is made between the service enterprising person (provider) 103 and the contractor 101 in the above-described first and second embodiments, the maker 105 directly makes rental contract with the contractor 101 to operate the storage medium 11 of the contractor in the third embodiment.

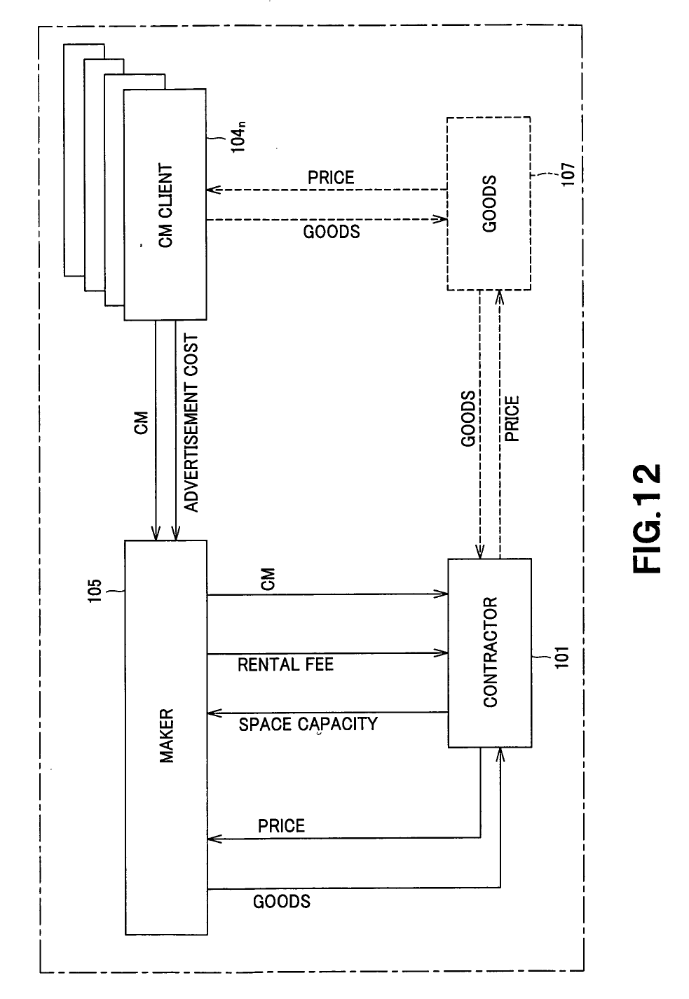

FIG. 12 is a model view showing a storage medium operational method of this embodiment. As shown in FIG. 12, maker 105 makes the rental contract for lending a predetermined area of that electronic equipment 10 between the maker 105 and the purchaser who has made utilization approval of a predetermined area (space capacity) of the storage medium 11. Further, the server apparatus 30 that the maker 105 performs management is used to transmit, etc. contents to the rental area 20 where the rental contract has been made to operate that rental area 20 through the network. As contents to be transmitted, the maker 105 himself may prepare CM of goods that the maker 105 himself manufactures, or new product that the maker 105 himself manufactures, etc. to transmit such CM. In addition, similarly to the above, there may be employed an approach to collect CM clients 104ₙ to make contract of CM transmission, whereby the maker 105 performs agency to various enterprises.

In this embodiment, similarly to the first embodiment, the contractor 101 lends, as rental area 20, space area of the electronic equipment 10 that the contractor 101 himself has to have ability to collect rental fee. In addition, since the service enterprising person (provider) 103 is not caused to undergo intervention, it is possible to cheaply set advertisement cost paid along with contents that the CM client 104ₙ provides, and since the maker 105 himself performs management of the server apparatus 30 to operate the storage medium 11, it is possible to develop electronic equipment 10 provided with storage medium 11 easy to operate to offer it to purchaser serving as the contractor 101. Thus, operational (utilization) efficiency of the storage medium 11 can be improved.

While the invention has been described in accordance with preferred embodiments thereof illustrated in the accompanying drawings and described in the above description in detail, it should be understood by those ordinarily skilled in the art that the invention is not limited to the embodiments, but various modifications, alternative constructions or equivalents can be implemented without departing from the scope and spirit of the present invention as set forth and defined by appended claims. For example, while explanation has been given in the above-described first to third embodiments in connection with the case where space area at the storage medium 11 such as hard disc, etc. of computer device is operated as rental area 20, there may be employed electronic equipments, e.g., STB, and hard disc recorder or game equipment, etc. having fixed storage media in a manner as described above.

Moreover, while explanation has been given by taking, as an example, maker which provides goods as the contents provider, if there is employed, e.g., an approach to provide input picture at the time of rental contract, etc. to thereby allow the service enterprising person (provider) to grasp, e.g., contractor information such as age, etc. of the contractor who makes contract to lend space capacity, there may be employed an approach to focus the target to, e.g., desired age group to transmit experience version, etc. of software such as new game, etc. as contents to obtain the impression thereof, or to efficiently make various questionnaires, etc. of goods for child or adult, or goods for male or female, etc.

Further, while explanation has been given in the above-described first to third embodiments on the premise that the rental contract is made between electronic equipment that the contractor has and management server that the service enterprising person (provider) or the maker performs management, the present invention is not only required to efficiently operate a predetermined area of the storage medium of the electronic equipment that the contractor has, but is not also necessarily required to employ the rental contract. Namely, utilization contract with respect to the fact that a predetermined area of the storage medium of the electronic equipment is utilized by free of charge may be made between electronic equipment that the contractor has and the management server that the service enterprising person (provider) or the maker, etc. performs management. In this case, for example, in the case where contractor who is owner of the electronic equipment in which utilization contract has been made views sent contents such as CM, etc., fee may be paid.

Furthermore, if CM clients, etc. are disclosed in the server apparatus so that the contractor can select CM client, the contractor can efficiently view interested contents, and CM client makes fulfillment of contents so that he can be selected by the contractor, etc. so that service can be improved.

### Industrial Applicability

As explained above in detail, in the storage media operational system according to the present invention, if utilization contract is made between electronic equipment having extra storage medium, e.g., for the reason who it is not used at present and the server apparatus, it is possible to lend a predetermined area within the storage medium of the electronic equipment to the server apparatus to operate it through the network.

In addition, if the utilization contract is caused to be the rental contract that the electronic equipment lends a predetermined area within the storage medium thereof to the server apparatus by the charge with rental fee, the owner of the electronic equipment can obtain rental fee. For this reason, lowering of the value of the proprietary right (ownership) of the electronic equipment by depreciation can be reduced, and the server apparatus can freely use a predetermined area within the storage medium in which the utilization contract has been made. For example, if contents providers are collected to selectively transmit contents such as advertisement, etc., in the case where the contents provider is manufacturer of the electronic equipment, the manufacturer can further efficiently perform advertisement by using that electronic equipment in addition to the price obtained by selling the manufactured electronic equipment. Thus, there is extremely useful system for both purchaser of the electronic equipment and the manufacturer thereof.

1. A storage media operational system including electronic equipments wherein the electronic equipment includes a storage medium accessible through the network from the server apparatus, and communication means which communicates with the server apparatus through the network, and
wherein the server apparatus at least includes communication means which communicates with the electronic equipments through the network, thus to make utilization contract with respect to the fact that a predetermined area within the storage medium of the electronic equipment between the server apparatus and the electronic equipment, whereby the server apparatus operates, through the network, the predetermined area of the electronic equipment in which the utilization contract has been made.

2. The storage media operational system as set forth in claim 1, wherein the utilization contract is rental contract that the electronic equipment lends a predetermined area within the storage medium thereof to the server apparatus by charge with rental fee.

3. The storage media operational system as set forth in claim 1, wherein the server apparatus transmits, through the network, contents to the predetermined area of the electronic equipment in which the utilization contract has been made.

4. The storage media operational system as set forth in claim 3, wherein the contents are contents with viewing fee that an owner of the electronic equipment in which the utilization contract has been made receives viewing fee from the service enterprising person (provider) in the case where a contractor who is the owner views the contents.

5. The storage media operational system as set forth in claim 1, wherein the server apparatus makes contents transmission contract which transmits contents provided from the contents provider to a predetermined area within the storage medium through the network between the server apparatus and a contents provider who provides contents, and
wherein the contents provider provides contents with service intervention charge which is paid from the contents provider to the service enterprising person (provider).

6. The storage media operational system as set forth in claim 5, wherein the service intervention fee which is paid from the contents provider of the contents with service intervention fee to the service enterprising person (provider) includes a first service intervention fee paid in the case where the contents are transmitted from the server apparatus to a predetermined area of the storage medium, and a second service intervention fee paid in the case where the contents are viewed.

7. The storage media operational system as set forth in claim 3, wherein the contents are commercial message.

8. The storage media operational system as set forth in claim 3, wherein the server apparatus selects the contents on the basis of contractor information indicating at least one or more of the area where a contractor who is owner of an electronic equipment in which the utilization contract has been made resides, age of the contractor, interest of the contractor, presence or absence of audience of the contents, and size of capacity and rental period of a predetermined area within the storage medium to transmit selected one.

9. The storage media operational system as set forth in claim 8, wherein the electronic equipment includes contractor information input means that the contractor inputs the contractor information.

10. The storage media operational system as set forth in claim 3, wherein the server apparatus includes detecting means for detecting whether or not the contractor views the contents to select the contents on the basis of the detection result to transmit selected one.

11. The storage media operational system as set forth in claim 3, wherein the electronic equipment includes contents selector means which can select desired contents to select, by the contents selector means, the contents presented through the communication means of the server apparatus, whereby the server apparatus transmits the selected contents to the electronic equipment.

12. The storage media operational system as set forth in claim 2, wherein the service enterprising person (provider) sets the rental fee on the basis of contractor information indicating at least one or more of the area where a contractor who is owner of an electronic equipment in which the utilization contract has been made, age of the contractor, interest of the contractor, presence or absence of audience of the contents, and size of capacity and lending period of a predetermined area within the storage medium.

13. The storage media operational system as set forth in claim 5, wherein the contents provider sets the service intervention fee on the basis of contractor information indicating at least one or more of the number of contractors who are owners of electronic equipments which have made utilization contract between the contents provider and the service enterprising person (provider), the area where the contractor resides, age of the contractor, interest of the contractor, presence or absence of audience of the contents, and size of capacity and rental period of a predetermined area within the storage medium.

14. The storage media operational system as set forth in claim 1, wherein the service enterprising person (provider) is a manufacturer of the electronic equipment.

15. The storage media operational system as set forth in claim 5, wherein the contents provider is manufacturer of the electronic equipment.

16. A storage media operational method for a storage media operational system including electronic equipments connected to network, and a server apparatus that service enterprising person (provider) performs management,
wherein the electronic equipment includes a storage medium accessible through the network from the server apparatus, and communication means which communicates with the server apparatus through the network, and the server apparatus includes communication means which communicates with the electronic equipment through the network to make utilization contract with respect to the fact that a predetermined area within the storage medium of the electronic equipment is utilized between the server apparatus and the electronic equipment, and
wherein the server apparatus operates the electronic equipment in which the utilization contract has been made though the network.

17. The storage media operational method as set forth in claim 16, wherein the utilization contract is rental contract which lends a predetermined area within the storage medium to the server apparatus by charge with rental fee.

18. The storage media operational method as set forth in claim 16, wherein the server apparatus transmits, through the network, contents to the predetermined area of the electronic equipment in which the utilization contract has been made.

19. An electronic equipment connected to a server apparatus that a service enterprising person (provider) performs management through network, the electronic equipment including
a storage medium accessible through the network from the server apparatus,
communication means for performing communication with the server apparatus through the network, and
control means for permitting the server apparatus to operate a predetermined area within the storage medium through the network under the condition where utilization contract with respect to the fact that the predetermined area is utilized has been made.

20. The electronic equipment as set forth in claim 19, wherein the utilization contract is rental contract which lends the predetermined area within the storage medium to the server apparatus by charge with rental fee.

21. The electronic equipment as set forth in claim 19, wherein contents are transmitted from the server apparatus to the predetermined area through the network.

22. A server apparatus used for a storage media operational system including electronic equipments connected to network, and a server device that service enterprising person (provider) performs management, the electronic equipment including a storage medium accessible through the network from the server apparatus, and communication means which communicates with the server apparatus through the network, the server apparatus including communication means which communicates with the electronic equipment through the network,
the server apparatus including
communication means which communicates with the electronic equipment through the network, and
control means which makes utilization contract with respect to the fact that a predetermined area within the storage medium of the electronic equipment is utilized between the control means and the electronic equipment to operate, through the network, the predetermined area of the electronic equipment in which the utilization contract has been made.

23. The server apparatus as set forth in claim 22, wherein the utilization contract is rental contract which lends a predetermined area within the storage medium from owner of the electronic equipment by charge with rental fee.

24. The server apparatus as set forth in claim 22, wherein the control means transmits contents to the predetermined area of the electronic equipment in which the utilization contract has been made through the communication means.
